(19) United States
(12) Patent Application Publication
(10) Pub. No.: US 2010/0085371 A1
(43) Pub. Date: Apr. 8, 2010

(54) OPTIMAL 2D TEXTURING FROM MULTIPLE IMAGES

(75) Inventors: Yonatan Wexler, Redmond, WA (US); Eyal Ofek, Redmond, WA (US); Billy Chen, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/244,424

(22) Filed: Oct. 2, 2008

(51) Int. Cl. G09G 5/00

(52) U.S. Cl. 345/582

(57) ABSTRACT

One or more images of an object are obtained. These are then warped onto the object. The object may be divided into sites where sites are overlapping circular regions of the object. For each site, a neighborhood graph may be created where each site is a node in the graph and each pair of sites with overlapping regions is connected by an edge. A list of covers of each site may be created where the list contains all the possible labels for that node. Each image that covers part of the site may be reviewed including all possible shifts up to some number of pixels. A cost may be assigned to each cover and costs for each of the covers may be calculated. The cover with the lowest cost may be selected. If the costs are too high, the resolution may be lowered, one or more possible covers may be selected and then the analysis may be performed using the selected covers at a higher resolution.

### BACKGROUND

This Background is intended to provide the basic context of this patent application and it is not intended to describe a specific problem to be solved.

Textures are important for the visual quality of 3D models of buildings. The texture is usually generated from a set of images of the original object. Many works deal with texturing models from multiple images, assuming that the 3D model is a very accurate one. Using such an accurate model, each image can be projected onto the model surface, and textures that originate from different images can fit nicely. However, in many cases we cannot use an accurate enough model, since we have not modeled one, or that we need to use a simplified or an approximated model for quick rendering or distribution. The difference between the approximate model and the real object may cause artifact where different images that are projected onto the approximated model to not fit well.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method and system of adding texture to a three dimensional object is disclosed. A first image and a second image of an object are obtained where the first image is related to the second image. The first image and the second image may be warped onto the object. The warped object may be divided into sites where sites are overlapping circular regions of the object. For each site, a neighborhood graph may be created where each site is a node in the graph and each pair of sites with overlapping regions is connected by an edge. A list of covers of each site may be created where the list contains all the possible labels for that node. Each image that covers part of the site may be reviewed including all possible shifts of each image plus or minus 2 pixels. A cost may be assigned to each cover and costs for each of the covers may be calculated. The cover with the lowest cost may be selected. If the costs are too high, the resolution may be lowered, one or more possible covers may be selected and then the analysis may be performed using the selected covers at a higher resolution.

### BRIEF DESCRIPTION OF THE DRAWINGS

FIG. 1 is an illustration of a portable computing device;

FIG. 2 is an illustration of a method of adding texture to an image;

FIG. 3 is an illustration of several images that are used to create a single, textured image;

FIG. 4 is an illustration of pixels and sites covering the pixels;

FIG. 5 is an illustration of pixels at a lower resolution;

FIG. 6 is an illustration of pixels and overlapping sites;

FIG. 7 is an illustration of the node relationship of pixels and sites; and

FIG. 8 is an illustration of calculating an edge cost.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is specifically defined by reciting the word “means” and a function without the recital of any structure, it is not intended that the scope of any claim element be interpreted based on the application of 35 U.S.C. §112, sixth paragraph.

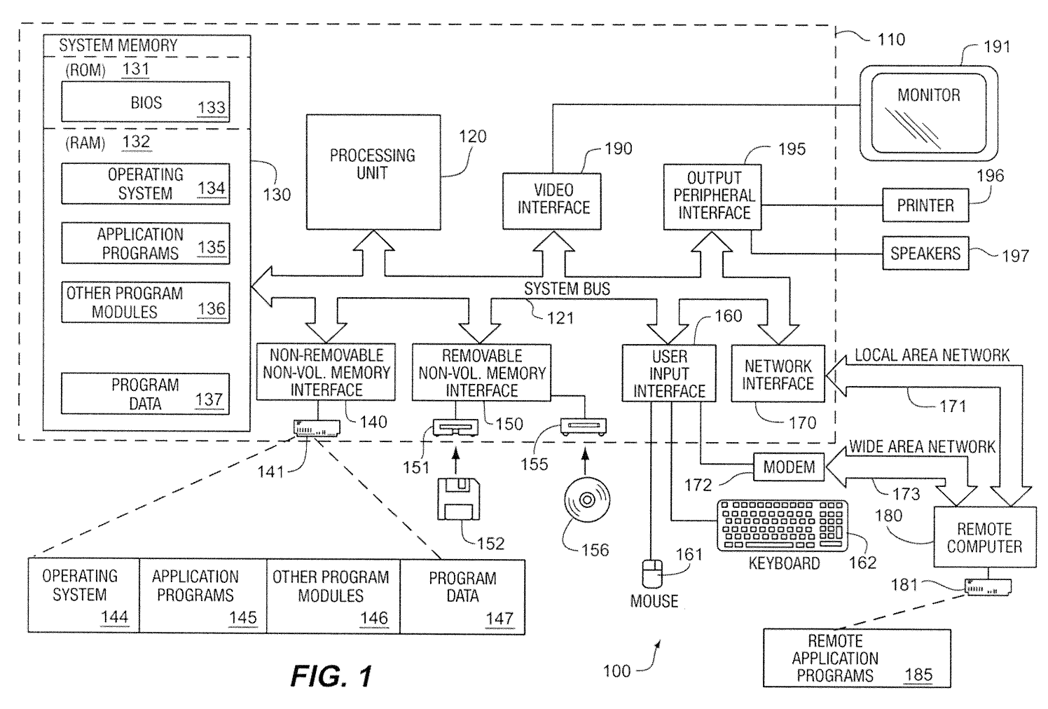

FIG. 1 illustrates an example of a suitable computing system environment 100 that may operate to display and provide the user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137.

The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

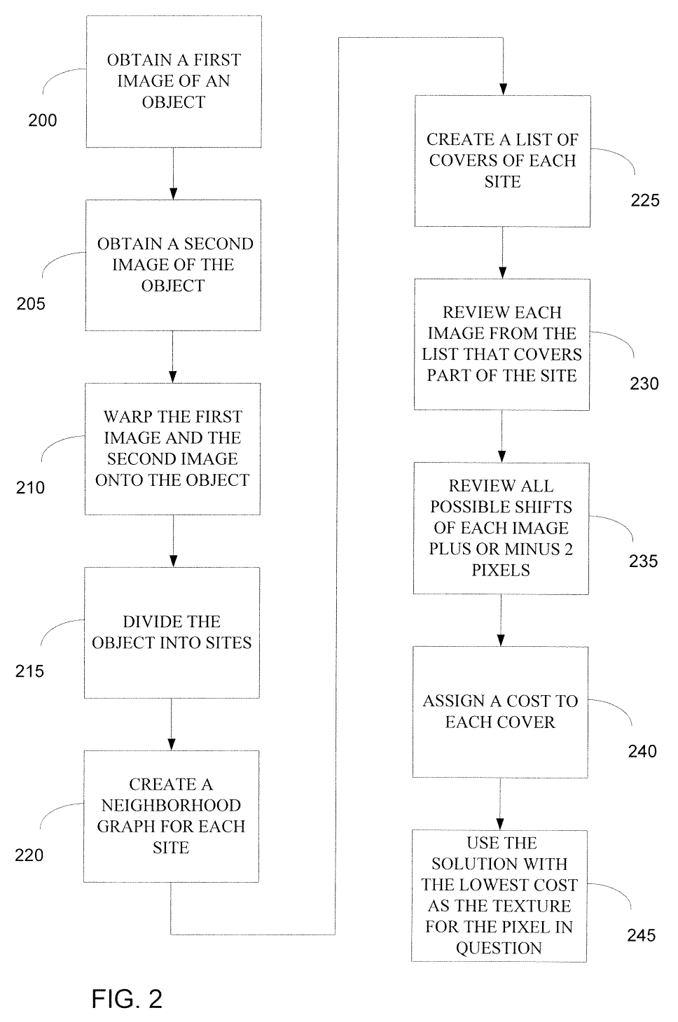

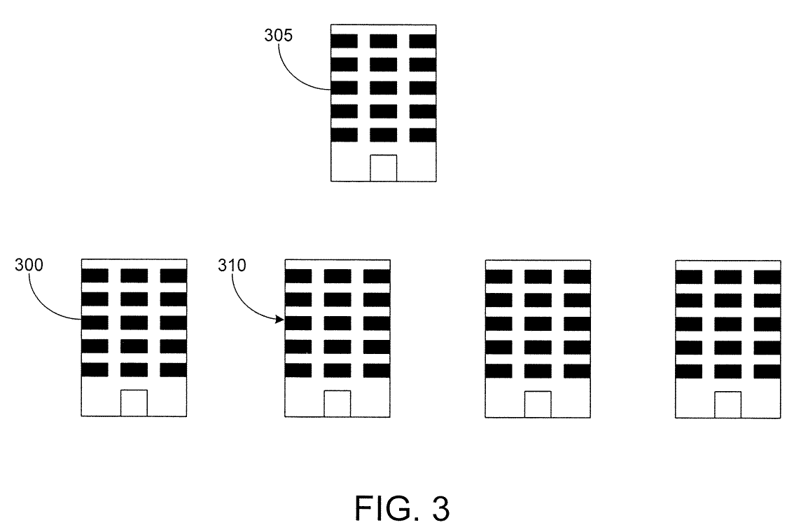

FIG. 2 may illustrate a method of adding texture to a three dimensional image. In one embodiment, the image is a photo, but other images are possible. At block 205, one or more images of an object 305 may be retrieved. For example, in FIG. 3, a first image 300 of an object 305 may be obtained and at block 205, a second image 310 of the object 305 may be obtained. The first 300 and second image 310 may be related in that the same object 305 may be part of each image. There may be many more images than the first image 300 and the second image 305. The object 305 could be any object such as a building, a house, an animal or a car. In some embodiment, the object 305 is building and the images 300 310 may be photos of the building 305.

Images such as images 300 310 may be at different angles, heights, distances, focal lengths, camera types, etc. The images may be used to create an approximate geometry using the images 300 310 and from the various sensors in which the object 305 is visible. The images 300 310 may include a street-side perspective which may be useful for the lower parts of the building, a birds-eye view which may be useful for top part of the buildings, and Ultra-cam images which are useful mostly for the roofs. In one embodiment, the cameras are calibrated and bundled with known projection models.

Each input image may have a known resolution and a known fidelity which may be factored in when deciding which ones are preferred in each part of the façade. The output may be a single texture such as the texture in image 305 that is done in such a way to minimize visual artifacts.

In some embodiments, the method may proceed object by object and each object face may be textured separately. The method may also assume that mis-registration or misalignment of the object 305 from the images (such as 300, 310) may be constrained only to translations in the façade plane. This models the type of errors common seen, as camera rotation is solved much more accurately than translation. The images 300 310 may be divided into a collection of overlapping regions and each will eventually contain image information from one of the sources 300 310. The optimization process may be used to choose which part of which image is taken.

At block 210, the first image 300 and the second image 310 may be warped onto the object 305. The warping onto the face of the object 305 may occur as a pre-process. The pre-warping may define the maximal resolution that is used by reviewing the maximum resolution of the images 300 310 used. In some embodiments, the image 300 310 is stretched to reduce protrusions and indentations present in the image 300 310 and then the image 300 310 may be shrunk to fit the object 305.

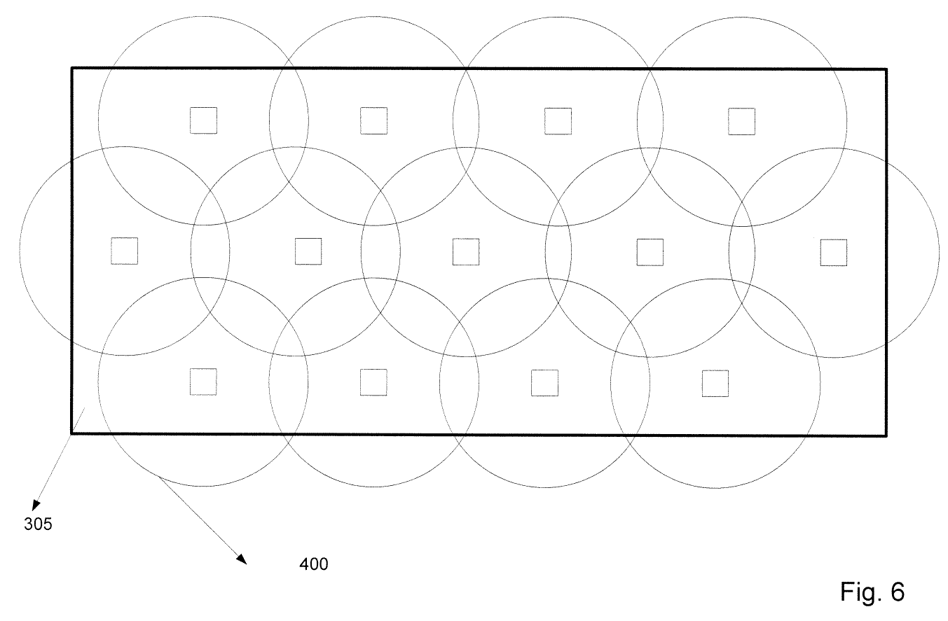

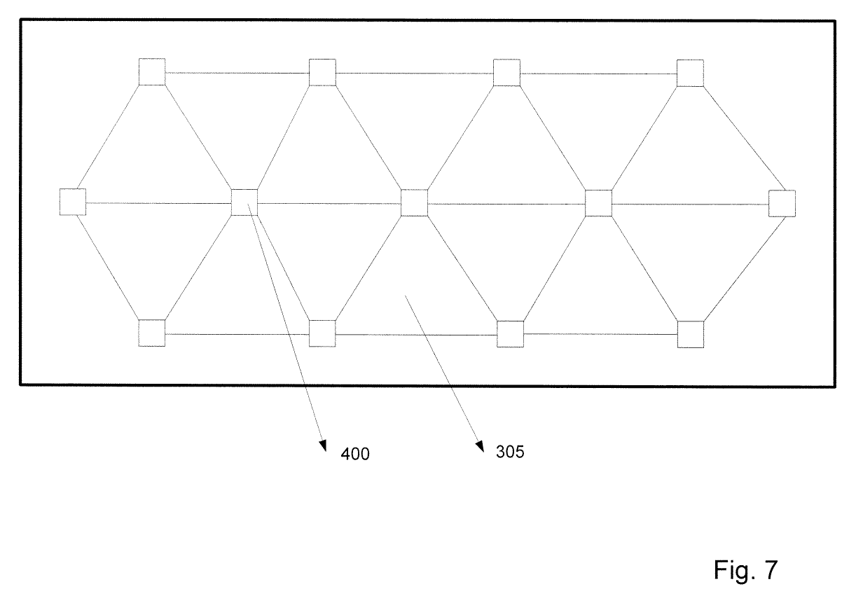

At block 215, the object 305 may be divided into sites 400. Sites 400 may be overlapping circular regions of the object 305. For example, FIG. 6 may illustrate sites 400 being applied over the object 305 and FIG. 7 may illustrate how six different surrounding sites 400 connect to each site 400. The use of circular windows over sites may help reduce block artifacts. Moreover, as each site is connected to six others (see FIGS. 6 and 7), rather than four in traditional grids, the problem may be better constrained. Each circular site 400 or regions may contain a limited number of pixels, such as 15 pixels in one embodiment.

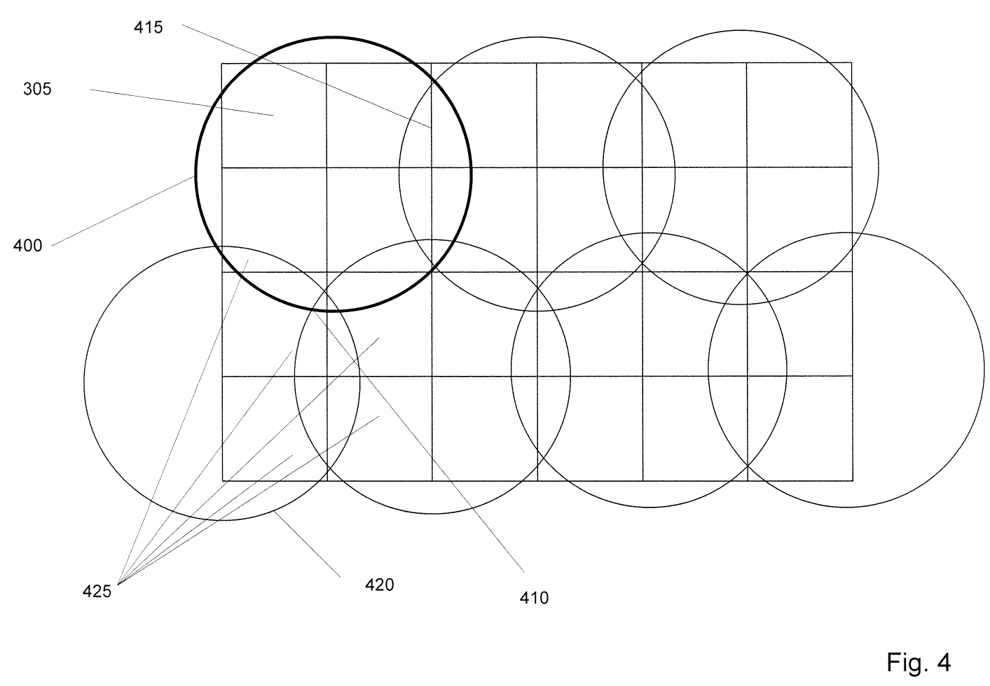

Referring to FIG. 2, at block 220, for each site 400 (FIG. 4), a neighborhood graph 410 may be created where each site 400 is a node in the graph and each pair of sites 400 with overlapping regions is connected by an edge 415.

At block 225, a list of covers 420 of each site may be created. The list may contain all the possible covers for that node 400. For example, each square in FIG. 2 may be a different image 300 310. There may be five photos that illustrate different portions of a northwest corner of a building. Each of the five may be added to the list of possible covers 420. Each site may have a list of possible sources that can cover its region. This list depends on the known information about the available imagery. The list may contain complete covers 420 (that is, covers that are completely contained inside the image). In the case that other information is known (such as occlusions, image quality etc.) this can be used to cull the list. The list may contain transformed copies of the images, such as shifts and rotations.

At block 230, each image 300 310 from the list that covers part of the site 305 may be reviewed. Various factors may be obtained from the images 300 310 such as a color measurement, a texture measurement, image density information, neighboring pixel information, etc.

At block 235, all possible shifts of each image plus or minus 2 pixels may be reviewed. In this way, image 300 310 shifts may be taken into account and images 300 310 that may be useful will not be overlooked. In addition, improved registration of the first image 300 and second image 310 may be obtained.

At block 240, a cost may be assigned to each cover 420. As previously explained, a cover may be an image 300 310 that covers a site 400. For example, all the pixels 425 may be covered by site 400, meaning the image 300 310 related to site 420 may be a cover 420 for pixels 425. Every choice of a cover 400 may have an associated cost which is a function of the image 300 310 quality and coverage. When a multi-scale process is used, the solution from the coarser level may factor into the costs of the label in the current level.

In one embodiment, images 300 310 with a higher quality have a lower cost than images 300 310 with lower quality. Similarly, images 300 310 that are similar have a lower cost and images that are different have a higher cost. The method may assign a higher cost to images 300 310 that have different color values and a lower cost to images 300 310 that have a similar color value. The method may also assign a higher cost to images 300 310 that different have texture values and a lower cost to images that have a similar texture value. A higher cost may be assigned to images 300 310 that have a different neighborhood and a lower cost may be assigned to images that are from a similar neighborhood. Other factors may be added to the cost equation and in some embodiments, the costs are given weights which may be adjusted by the application or by the user.

If the calculated costs of the various images 300 310 is high, such as beyond a threshold, the method may switch to a lower resolution and the method may be repeated. For example, the problem may be approached in lower resolution to eliminate images 300 310 that are not close in high resolution and propagating the solution to the next resolution. In such cases, the list at some resolution level will be an expansion of the best choices made in the level preceding it.

In order to cope with large size textures or many images 300 310, the method may solve the texturing in a multi-scale image pyramid. In one embodiment, a Gaussian pyramid of the textures is used to find a solution from the coarsest to the finest resolution. Each level may be used as an initial guess for the next one. A site s at location (x, y) level l expands the list of options around the solutions of site sⁱ around location

$$( \frac{x}{2} , \frac{y}{2} )$$

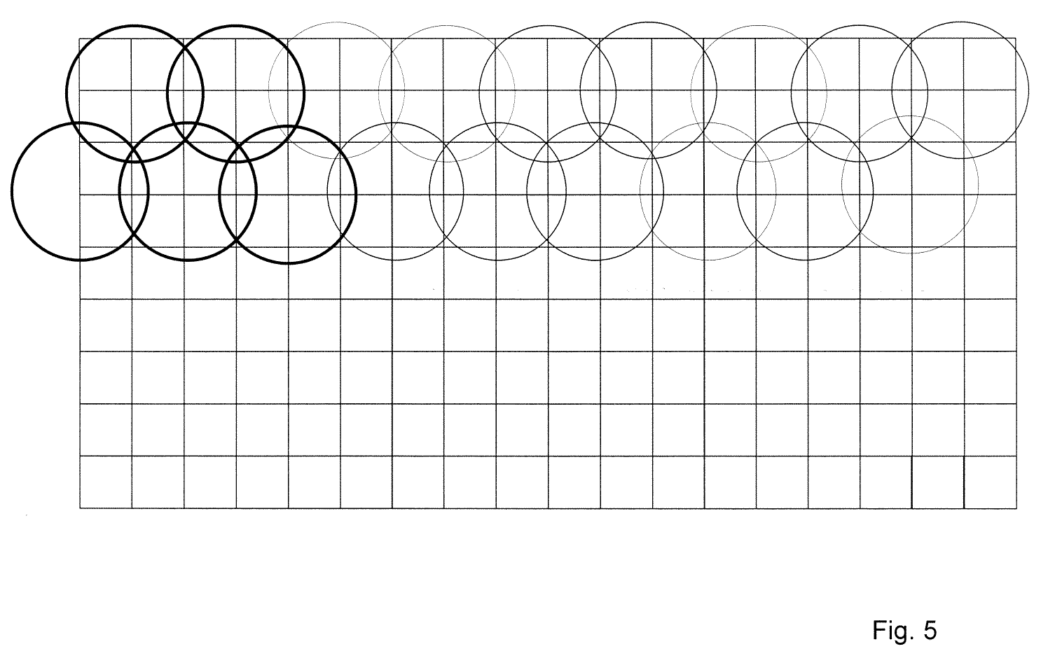

in level l+1. Level 0 of the pyramid is the original resolution which is shrunk in subsequent levels (a factor of 2 for example, but if convergence isn't good enough a factor of \sqrt{2} may also be used. The number of sites 400 in each level decreases quadratically. For example, in FIG. 4, the bold circle 400 in the finer resolution is expand the coarse scale solution of the circle C that is illustrated in FIG. 5. That is, if the coarse scale solution assigns location \vec{p} in image I then each of the sites at the finer resolution in FIG. 5 may have location 2\vec{p}+Ω±ρ in the same image 300 310 in their lists of labels. The symbol Ω may denotes the offset of each circle with respect to C and ρ may denote the chosen x-y freedom to move the texture at that scale (typically 2 will be used).

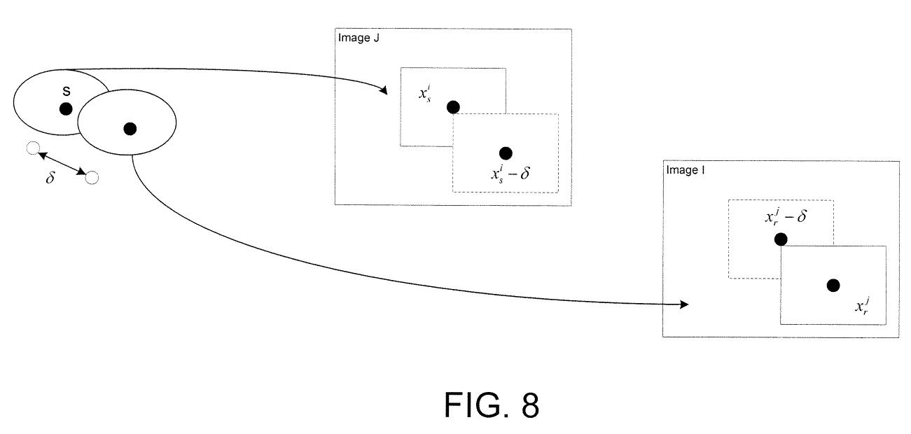

Referring to FIG. 8, the cost of choosing covers 420 for neighboring sites in the graph may be given by:

Θₛᵣ(xₛ, xᵣ)=min{SSD(xₛⁱ, xₛ^{j}−δ), SSD(xᵣ^{j}, xᵣⁱ+δ)′}

In this example, sites s,r which are neighbors due to the intersection of their neighborhood, have a cost that is proportional to the similarity of the shifted windows. A rectangular windows may be used for this comparison.

At block 245, the solution with the lowest cost may be used as the texture for the pixel in question. In other words, the pixel that has been determined to have the lowest cost and be most likely the correct pixel is used to create the pixel in question. Ideally, the cost of the overlap between two sites 400 would be 0. The method may iterate through different arrangements until the cost is as close to 0 as possible.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of adding texture to a three dimensional image comprising
obtaining one or more images of an object wherein the images are related;
warping the image(s) onto the object;
dividing the object into sites wherein sites comprise overlapping circular regions of the object;
for each site,
creating a neighborhood graph where each site is a node in the graph and each pair of sites with overlapping regions is connected by an edge
creating a list of covers of each site wherein the list contains all the possible labels for that node
reviewing each image that covers part of the site
reviewing all possible shifts of each image
assigning a cost to each cover further comprising
images with a higher quality have a lower cost than images with lower quality;
creating a graph and solving for its minimal cost;
selecting the site with the lowest cost.

2. The method of claim 1, wherein the images are from calibrated cameras with known projection models.

3. The method of claim 2, further comprising using photometric information of the first image and second image to assist the method.

4. The method of claim 1, further wherein each circular regions contain arbitrary shape and size.

5. The method of claim 1, wherein a first circular region is connected with six other circular regions.

6. The method of claim 1, wherein images that are similar have a lower cost and images that are different have a higher cost.

7. The method of claim 1, wherein the cost further comprises assigning a higher cost to images that have different color values and a lower cost to images that have a similar color value.

8. The method of claim 1, wherein the cost further comprises assigning a higher cost to images that have different texture values and a lower cost to images that have a similar texture value.

9. The method of claim 1, wherein the cost further comprises assigning a higher cost to images that have a different neighborhood and a lower cost to images that re from a similar neighborhood.

9. The method of claim 1, wherein if the costs of the images is high, switching to a lower resolution and repeating the method.

10. The method of claim 8, further comprising finding a match in the lower resolution and then switching to the higher resolution and repeating the method.

11. A computer storage medium comprising computer executable code for adding texture to a three dimensional image, the computer executable code comprising code for:
obtaining a first image of an object;
obtaining a second image of the object wherein the first image is related to the second image and wherein the first image and the second image are from calibrated cameras with known projection models;
warping the first image and the second image onto the object;
dividing the object into sites wherein sites comprise overlapping circular regions of the object;
for each site,
creating a neighborhood graph where each site is a node in the graph and each pair of sites with overlapping regions is connected by an edge
creating a list of covers of each site wherein the list contains all the possible labels for that node
reviewing each image that covers part of the site
reviewing all possible shifts of each image plus or minus 2 pixels
assigning a cost to each cover further comprising
images with a higher quality have a lower cost than images with lower quality;
selecting the site with the lowest cost.

12. The computer storage medium of claim 11, further comprising computer executable instructions for using photometric information of the first image and second image to assist the method.

13. The computer storage medium of claim 11, wherein a first circular region is connected with six other circular regions.

14. The computer storage medium of claim 11, further comprising computer executable instructions for at least one selected from a group comprising:
assigning a higher cost to images that have different color values and a lower cost to images that have a similar color value;
assigning a higher cost to images that have different texture values and a lower cost to images that have a similar texture value; and
assigning a higher cost to images that have a different neighborhood and a lower cost to images that re from a similar neighborhood.

15. The computer storage medium of claim 11, wherein if the costs of the images is high, computer executable instructions for switching to a lower resolution and repeating the method.

16. The computer storage medium of claim 11, further comprising computer executable instructions for finding a match in the lower resolution and then switching to the higher resolution and repeating the method.

17. A computer system comprising a processor, a memory in communication with the processor and an input output circuit; the processor being configured in accordance with computer executable instructions for adding texture to a three dimensional image, the computer executable instructions comprising instructions for:
obtaining a first image of an object;
obtaining a second image of the object wherein the first image is related to the second image and wherein the first image and the second image are from calibrated cameras with known projection models;
warping the first image and the second image onto the object;
dividing the object into sites wherein sites comprise overlapping circular regions of the object;
for each site,
creating a neighborhood graph where each site is a node in the graph and each pair of sites with overlapping regions is connected by an edge
creating a list of covers of each site wherein the list contains all the possible labels for that node
reviewing each image that covers part of the site
reviewing all possible shifts of each image plus or minus 2 pixels
assigning a cost to each cover further comprising
images with a higher quality have a lower cost than images with lower quality;
selecting the site with the lowest cost.

18. The computer system of claim 17, further comprising computer executable instructions for at least one selected from a group comprising:
assigning a higher cost to images that have different color values and a lower cost to images that have a similar color value;
assigning a higher cost to images that have different texture values and a lower cost to images that have a similar texture value; and
assigning a higher cost to images that have a different neighborhood and a lower cost to images that re from a similar neighborhood.

19. The computer system of claim 17, wherein if the costs of the images is high, computer executable instructions for switching to a lower resolution and repeating the method.

20. The computer system of claim 17, further comprising computer executable instruction for finding a match in the lower resolution and then switching to the higher resolution and repeating the method.
